(19) United States
(12) Patent Application Publication
(10) Pub. No.: US 2007/0098058 A1
(43) Pub. Date: May 3, 2007

(54) Method and apparatus for compensating a signal for transmission media attenuation

(76) Inventor: Arnold M. Frisch, Portland, OR (US)

Correspondence Address: SMITH-HILL AND BEDELL, P.C., 16100 NW CORNELL ROAD, SUITE 220, BEAVERTON, OR, 97006, US

(21) Appl. No.: 11/264,789

(22) Filed: Oct. 31, 2005

(51) Int. Cl. H04L 5/16

(52) U.S. Cl. 375/219

(57) ABSTRACT

A compensation circuit within the data transmission system compensates a signal for transmission media attenuation by amplifying the signal with a gain
Gain=K₀+K_{0.5}f^{0.5}+K₁f¹+K₂f²+ . . . Kₙfⁿ
where f is signal frequency, n is an integer larger than 0, and coefficients K₀, K_{0.5}, and K₁, K₂ . . . Kₙ are adjustable. Coefficient K₀ is adjusted to compensate for DC losses of the signal in the transmission media. Coefficient K_{0.5} is adjusted so that the term K_{0.5}f^{0.5} compensates for skin effect losses of the signal in the transmission media. Coefficients K₁, K₂ . . . Kₙ are adjusted so that the n-term expression (K₁f¹+K₂f²+ . . . Kₙfⁿ) compensates for dielectric absorption losses in the transmission media. The compensation circuit may be used either as a pre-emphasis circuit by processing the signal before it is sent over the transmission media, or as an equalization circuit processing the signal after it is sent over the transmission media. In applications where skin effect losses are negligible, the term K_{0.5}f^{0.5} can be omitted.

### BACKGROUND OF THE INVENTION

1. Field of the Invention

The invention relates in general to data transmission systems and in particular to a method and apparatus for compensating a data signal for frequency-dependant attenuation in transmission media.

2. Description of Related Art

FIG. 1 depicts an example prior art figital data tramsmission system including a transmitter 10 converting an input digital data sequence T_{X} into a signal V_{T} transmitted to a receiver 12 via transmission media 14. Receiver 12 then converts the received signal V_{T} signal back into an output data sequence R_{X} matching input data sequence T_{X}.

FIG. 2 illustrates the voltage of signal V_{T} as a function of time. Transmitter 10 organizes the V_{T} signal into a succession of data cycles of uniform duration, and during each data cycle, transmitter 10 drives the T_{X} signal to a high or low logic level depending on whether the current bit of the input T_{X} signal is a logical “1” or a logical “0”. FIG. 2 shows how the V_{T} signal might look when representing the TX data sequence 10001011. Receiver 12 samples the V_{T} signal during the middle of each data cycle and compares each sample to a reference voltage Vₒ midway between the V_{T} signal's high and low voltage levels, or to a complementary version of the V_{T} signal, to determine whether the sample represents a 1 or a 0. In some systems transmitter 10 will send a clock signal (not shown) to receiver 12 to tell it when to sample the V_{T} signal. In other systems receiver 12 will generate its own sampling clock signal by monitoring the timing of V_{T} signal transitions through reference level Vₒ to ascertain an appropriate phase and frequency for the sampling clock signal.

The gain of any device, such as for example an amplifier, a transmission line or any other transmission media, is defined as
gain=Vₒᵤₜ/Vᵢₙ
where Vₚᵤₜ is the device's output signal voltage and Vᵢₙ is the device's input signal voltage.

Electromagnetic signals, including electrical signals, radio frequence signals, optical signals and the like, undergo frequency-dependant attenuation as they pass through transmission media such as transmission lines, wave guides and other media. The amount of signal attenuation depends not only on the nature of the transmission media but also on signal frequency. For example, FIG. 3 is a graph of the gain of any signal passing through an example transmission line as a function of the frequency of the signal. Note that for frequencies below about 200 MHz, the attenuation is relatively small and independent of frequency, but becomes progressively larger at frequencies above 200 MHz.

A digital signal has a frequency spectrum that depends not only on the period of its data cycle but also on the nature of the data sequence it represents. Assume, for example, that the V_{T} signal of FIG. 1 a digital signal having an 8 GHz bit rate, or 125 picosecond data cycle, and that the transmission media 14 has the frequency response shown in FIG. 3. When signal V_{T} represents a data sequence including long sequences of all 0's and all 1's, such that its signal transitions occur at less than a 200 MHz rate, the signal can act like a low frequency signal that transmission media 14 attenuates very little. When the V_{T} signal represents a long alternating sequence of 1's and 0's such as {10101010 . . . }, it can act more like a 4 GHz sine wave that transmission media 14 greatly attenuates. When digital signal V_{T} represents a more random bit pattern, it behaves like a signal having several frequency components having amplitudes that can vary with time, and the transmission media 14 attenuates each frequency component by a different amount.

FIG. 4 is an “eye diagram” showing how a digital signal V_{T} representing a random data pattern might look upon departing from transmitter 10 if a large number of data cycles were superimposed over one another. FIG. 5 is an eye diagram illustrating the digital signal V_{T} representing a random data pattern might look upon arriving at receiver 12. As shown in FIG. 4 the V_{T} signal at the output of transmitter 10 does not vary much in amplitude or timing from cycle-to-cycle, so there is little variation in the high and low peak values during successive data cycles and a there is little variation in the timing with which the V_{T} signal crosses the reference voltage level Vₒ of FIG. 2. As illustrated in FIG. 5, the frequency dependant attenuation of transmission media 14 causes variation in the high and low logic levels of the V_{T} signal at the input to receiver 12 and also causes variation in the timing of signal peaks and level transitions from cycle-to-cycle. The latter effect is known as “jitter”.

FIGS. 4 and 5 are called an “eye diagrams” because the superimposed waveforms form an eye 15 or 17 in the middle of the diagram. The variation in logic level and the jitter in the V_{T} signal arriving at receiver 12 makes eye 17 of FIG. 5 both shorter and narrower than eye 15 of FIG. 4. The height of eye 17 at its middle is related to the signal-to-noise ratio of signal V_{T}; the taller the eye, the greater the noise level needed to drive the signal to a level that will cause receiver 12 to incorrectly determine a bit state the signal represents. The width of eye 17 relates to how difficult it may be for receiver 12 to sample signal V_{T} at the correct time during each data cycle, particularly if receiver 12 is generating its sampling clock internally based on the timing of V_{T} signal reference level crossings.

When we increase the length of transmission media 14, we increase its attenuation at all frequencies, causing eye 17 to be both shorter and narrower. We also decrease the height and width of eye 17 when we increase the bandwidth of signal V_{T} (i.e., when we decrease the period of its data cycle). When eye 17 becomes too short or thin, receiver 12 will be unable to correctly determine the state of each bit of the T_{X} data sequence signal V_{T} represents. Thus, there is a limit to the V_{T} signal bandwidth that the data transmission system can accommodate without failure, and that limit decreases as we increase the length of transmission media 14.

Compensation

A data transmission system can increase the bandwidth limit of its transmission media by selectively boosting the various frequency components of a signal to compensate for their attenuation in the transmission media. In a “pre-emphasis” system, signal transmitter 10 of FIG. 1 compensates for transmission media attenuation by filtering and amplifying the signal before sending it over transmission media 14, while in an “equalization” system, signal receiver 10 compensates for transmission media attenuation by filtering and amplifying the signal after it passes through the transmission media, but before the receiver processes it to extract the R_{X} data sequence.

FIG. 6 illustrates a typical prior art pre-emphasis system. A transmitter 16 includes a buffer 22 for amplifying data signal Tₓ to produce a signal Vᵢₙ supplied as input to a pre-emphasis filter 24 having a transfer function designed to provide more gain at high frequencies than at low frequencies, in a way that compensates for the way transmission media 20 attenuates the transmitted signal V_{T}. A flat response amplifier 26 amplifies Vₒᵤₜ to an appropriate level and transmits it as signal V_{T} to receiver 18 via an impedance matching circuit 28 and transmission media 20.

FIG. 7 illustrates a typical prior art equalization system. A transmitter 30 converts the data sequence Tₓ without pre-emphasis into data signal V_{T} transmitted to receiver 32 via transmission media 34. An impedance matching circuit 35 within receiver 32 delivers the V_{T} signal as an input signal Vᵢₙ to an equalizer 36. Equalizer 36 selectively filters and amplifies the various frequency components of the Vᵢₙ signal to compensate for the frequency-dependant attenuation of transmission media 34, thereby producing an output signal Vₒᵤₜ. Additional digital signal processing circuits 38 process Vout to produce the Rₓ output data sequence.

FIG. 8 is a block diagram for an equalizer circuit included in a data sheet entitled “MAXIM 10.7 Gbps Adaptive Receive Equalizer”, published July, 2003 by Maxim Integrated Products. Equalizer circuit 39, which could be employed as equalizer 36 of FIG. 7, includes a flat frequency response amplifier 40 and a high pass frequency response amplifier 41, each amplifying the Vᵢₙ signal. A variable attenuator 42 attenuates the output of amplifier 40 by an amount controlled by a signal C1 to produce a signal V3, and another variable attenuator 43 attenuates the output of amplifier 41 by an amount controlled by a signal C2 to produce another signal V4. A summing amplifier 44 sums V3 and V4 to produce a signal V5, amplified by a limiting amplifier 45 to produce output signal Vₒᵤₜ. A feedback circuit 46 monitors low and high frequency bands of the V5 signal and produces control signals C1 and C2, to adjust the attenuation provided by attenuators 42 and 43 so that the V5 signal exhibits a desired frequency spectrum.

In some data systems, the Tₓ data input to transmitter 30 of FIG. 7 is encoded to cause the V_{T} signal to exhibit a particular frequency spectrum. For example, the Tₓ data may be produced by encoding a non-random bit sequence so that it appears as a pseudo random bit sequence having a limited and predictable range of frequency components. Equalizer 39 of FIG. 8 is intended for use in such a system, where the V_{T} signal is expected to exhibit a predictable spectral characteristic. Feedback circuit 46 monitors V5 and adjusts C1 and C2 so that V5 exhibits the desired spectral characteristics. Feedback circuit 46 decreases or increases the attenuation of attenuator 42 when the voltage of the low frequency components of V5 are too low or too high, and decreases or increases the attenuation of attenuator 46 when the voltage of high frequency components of V_{T} are too low or too high. When the nature of the expected frequency spectrum of V5 changes, it is necessary to change the nature of feedback circuit 46. Feedback control circuit 46 is not suitable for controlling C1 and C1 in a system where the V5 signal is not expected to exhibit predictable spectral characteristics. C1 and C2 could be set to fixed values in such a system to provide equalization if the frequency response of transmission media 34 is known and if the relationship between values of C1 and C2 and the Vᵢₙ-to-Vₒᵤₜ transfer function is known.

In any case, the ability of equalizer 39 to compensate for the transmission media attenuation depends in part on how well feedback control circuit can make its frequency response complement the frequency response of transmission media 34. Ideally, equalizer 39 would amplify each frequency component of the Vᵢₙ signal in proportion to the amount by which transmission media 34 attenuates that component of the VT signal. Although FIG. 3 illustrates the frequency response of an example transmission line, transmission media exhibit a wide variety of frequency responses. For example, while the transmission line frequency response illustrated in FIG. 3 begins to roll off at about 100 MHz, the frequency responses of other transmission lines may roll off at substantially higher or lower frequencies. The shape of the high frequency portion of the frequency response curve can also vary substantially, and in order to provide highly accurate compensation for a variety of transmission media, it is necessary to be able to tightly control the frequency response of the equalization or pre-emphasis circuit providing that compensation. The equalizer frequency response should closely match the inverse of the transmission media frequency response. Since equalization circuit 39 of FIG. 8 has only two control inputs C1 and C2, it has only two degrees of freedom with respect to matching the frequency response needed to ideally compensate for transmission media attenuation regardless of the frequency response characteristics of amplifiers 40 and 41. Thus while, equalization circuit 39 enables separate adjustment of the amplitudes of the DC and high frequency portions of its frequency response, it permits no adjustment of any other characteristic of its frequency response.

What is needed is an equalization or pre-emphasis circuit permitting highly accurate control over its frequency response.

### SUMMARY OF THE INVENTION

The attenuation of a signal passing through typical transmission media can be modeled as
Attenuation=1/(K₀f⁰+K_{0.5}f^{0.5}+K₁f¹+K₂f²+ . . . +Kₙfⁿ).
where f is signal frequency, n is an integer at least as large as 1. The term K₀f⁰ reflects the contribution of DC losses to signal attenuation, the term K_{0.5}f^{0.5} reflects the contribution of skin effect losses to signal attenuation , and the polynomial K₁f¹+K₂f²+ . . . +Kₙfⁿ reflects the contribution of dielectric absorption losses to signal attenuation.

A programmable compensating circuit in accordance with the invention compensates a signal for transmission media attenuation by amplifying the signal with a gain of
Gain=K₀f⁰+K_{0.5}f^{0.5}+K₁f¹+K₂f²+ . . . +Kₙfⁿ [A]
where coefficients K₀, K_{0.5}, and K₁, K₂ . . . Kₙ are adjustable constants. Thus coefficient K₀ can be adjusted to compensate for DC attenuation in the transmission media, coefficient K_{0.5} can be adjusted to compensate for skin effect attenuation in the transmission media, and coefficients K₁, K₂ . . . Kₙ can be adjusted so that the n-terms of the expression compensate for dielectric absorption loss attenuation in the transmission media. Generally the larger the number (n) of terms in the polynomial of expression [A], the more accurate the compensation, but in most applications a compensation circuit implementing expression [A] can provide highly accurate compensation when n is from 1 to 3.

Since the terms of expression [A] closely model the three different types of transmission media attenuation, and since these types of attenuation can be accurately measured or predicted based on the physical characteristics of the transmission media, the user of the programmable compensating circuit can easily determine appropriate values for the coefficients.

A compensation circuit in accordance with the invention can omit the K_{0.5}f^{0.5} term from the above gain expression [A] so that it provides a gain that is a pure polynomial of signal frequency f,
Gain=K₀f⁰+K₁f¹+K₂f²+ . . . +Kₙfⁿ [B]
A compensation circuit having the gain of expression [B] can compensate for transmission media losses as well as a compensation circuit having the gain of expression [A], but since skin effect losses are significant in most transmission media, a compensation circuit implementing the gain of expression [B] will normally require many more terms in its gain polynomial than a compensation circuit of the form of expression [A] in order to obtain an equivalent level of compensation accuracy, and will therefore require more hardware. However, when transmission media, such as for example a superconductor transmission line, does not have significant skin effect losses or conduction losses that are proportional to f^{0.5}, the K_{0.5}f^{0.5} term of expression [A] is superfluous, and a compensation circuit implementing expression [B] is suitable.

A compensation circuit in accordance with the invention may be used either as a pre-emphasis circuit by amplifying the signal before it is sent over the transmission media, or as an equalization circuit amplifying the signal after it is sent over the transmission media.

A compensation circuit in accordance with one embodiment the invention includes a set of filters, each amplifying the circuit input signal with a frequency response and gain defined by a separate term of expression [A] or [B]. A summing amplifier then sums and scales the filter outputs to produce a compensated output signal. Values of coefficients K₁, K₂ . . . Kₙ are independently adjustable.

A compensation circuit in accordance with another embodiment of the invention implements expression [A] by initially processing the input signal V_{IN} to produce a signal P₁=log(Vᵢₙ) and a signal P₂=log(fVᵢₙ). The circuit then amplifies signal P₁ with a gain of A₀ to produce a signal Q₀, summing Qₒ with 0 to produce a signal R₀, and then amplifies signal R₀ to produce a signal S₀=antilog(R₀). For each value of j of the set j={0.5, 1, 2, 3 . . . n), the circuit amplifies P2−P₁ with gain j to produce a signal Qⱼ, sums signal Qⱼ with a signal of magnitude log(Aⱼ) to produce a signal R, and processes signal Rⱼ to produce a signal Sᵢ=antilog(Rᵢ). The circuit then amplifies each signal Sⱼ with a separate gain Bⱼ and sums resulting signals to produce the output signal Vₒᵤₜ. For each value of j of the set j={0, 0.5, 1, 2, 3 . . . n), Aⱼ and Bⱼ are constants, at least one of which is adjustable. A similar circuit omitting portions of the circuit that generate signals Q_{0.5}, R_{0.5}, and S_{0.5} can implement expression [B].

### BRIEF DESCRIPTION OF THE DRAWINGS

FIG. 1 depicts a prior art data transmission system in block diagram form.

FIG. 2 is a timing diagram illustrating how a digital signal can represent a digital data sequence.

FIG. 3 is a frequency response diagram for a typical transmission media.

FIG. 4 is an eye diagram for a digital signal at an input of transmission media.

FIG. 5 is an eye diagram for a digital signal at an output of transmission media.

FIG. 6 depicts in block diagram form a prior art data transmission system employing a pre-emphasis circuit to compensate for transmission media attenuation.

FIG. 7 depicts in block diagram form a prior art data transmission system employing an equalizing circuit to compensate for transmission media attenuation.

FIG. 8 depicts in block diagram form a circuit for compensating for transmission media attenuation.

FIG. 9 depicts two series connected circuits in block diagram form.

FIG. 10 depicts in block diagram form an example compensation circuit in accordance with the invention.

FIG. 11 depicts the pre-scaling summing amplifier of FIG. 10 in more detailed block diagram form.

FIG. 12 is a schematic diagram depicting the cascode stage and one of the input stages of FIG. 11.

FIG. 13 is a schematic diagram depicting the output stage of the circuit of FIG. 11.

FIGS. 14-16 are schematic and block diagram depicting the input stages of the circuit FIG. 10 in more detail.

FIG. 17 depicts in block diagram form an example compensation circuit in accordance with an alternative embodiment of the invention.

FIG. 18 depicts in block diagram form a prior art data transmission system employing a pre-emphasis circuit to compensate for transmission media attenuation.

FIG. 19 depicts in block diagram form a prior art data transmission system employing an equalizing circuit to compensate for transmission media attenuation

FIG. 20 depicts a prior art digital filter in block diagram form.

FIG. 21 depicts a digital filter in accordance with the invention in block diagram form.

### DETAILED DESCRIPTION OF THE INVENTION

An electromagnetic signal, such as for example, an electrical signal, radio signal or optical signal, passing through a transmission line, wave guide or any other kind of transmission media, suffers an attenuation that is not only a function of the physical characteristics of the transmission media, but which is usually also a function of signal frequency. The invention relates to a method or apparatus for altering a signal passing through transmission media to compensate for frequency-dependant attenuation of the transmission media. The claims appended to this specification particularly point out and distinctly claim the subject matter of the invention. The following section of this specification describes preferred modes of practicing the invention recited in the claims. Although the following description includes numerous details in order to provide a thorough understanding of the preferred modes of practicing the invention, it will be apparent to those of skill in the art that other modes of practicing the invention need not incorporate such details.

As discussed above, FIG. 3 illustrates the frequency response of an example transmission media showing that the attenuation of a signal passing over that transmission media increases with signal frequency. The shape of the frequency response curve depends on several different effects.

We define the gain of a signal passing though a circuit as
gain=Vₒᵤₜ/Vᵢₙ
where Vᵢₙ is the input signal voltage and Vₒᵤₜ is the output signal voltage. A circuit that amplifies a signal such that Vₒᵤₜ>Vᵢₙ has a gain greater than 1 while a circuit that attenuates a signal such that Vₒᵤₜ<Vᵢₙ has gain less than 1. As discussed below, transmission media attenuates a signal by an amount that depends on the frequency of the signal.
DC Losses

FIG. 3, depicting the gain for an example transmission media (in this example a transmission line) n as a function of signal frequency, shows that the transmission media attenuates all signal frequencies but that attenuation is relatively small and substantially independent of signal frequency for low signal frequencies under about 100 MHz. The DC resistance of a transmission line conductor, the main source of low frequency signal losses, depends on the cross-sectional area, length and material characteristics of the conductor and is independent of signal frequency. The DC losses in a transmission line cause a voltage drop in a signal passing through the transmission line. Since the current of a low frequency signal is relatively well distributed over the entire cross-section of the conductor, the conductor resistance seen by a low frequency signal is relatively small. The amount of voltage loss in a low frequency signal is therefore also usually relatively small.

Skin Effect Losses

At signal frequencies above 100 MHz, signal attenuation in a transmission line conductor is an increasingly important function of frequency, in part due to the well-known “skin effect” losses. The current of a high frequency signal is not evenly distributed through the cross-sectional area of a conductor, but resides mostly in a “skin area” near the surface of the conductor. The resistance of a conductor is proportional to the cross-sectional area of the skin area, and since current of a high frequency signal is restricted to a smaller cross-sectional area of the conductor than current of a low frequency signal, higher frequency signal components are subject to more attenuation. The depth of the skin area decreases with signal frequency, and skin effect losses increase with the square root of frequency.

Dielectric Absorption Losses

A signal is also subject to attenuation due to absorption losses through dielectric material contacting the transmission media and providing a distributed shunt capacitance along the transmission media. These losses increase with frequency, thereby causing greater attenuation at higher signal frequency.

Transmission Media Attenuation Model

The attenuation of a signal passing through typical transmission media can be modeled as
Attenuation=1/(K₀f⁰+K_{0.5}f^{0.5}+K₁f¹+K₂f²+ . . . +Kₙfⁿ).
where f is signal frequency, n is an integer at least as large as 1.

The term K₀f⁰ reflects the contribution of DC losses to signal attenuation. The coefficient K₀ is a constant function of the structure, length and material characteristics of the transmission media and is independent of signal frequency. Since f⁰=1, the model correctly expresses DC attenuation as being independent of signal frequency. In the example of FIG. 3, K₀ is approximately 0.7 dB.

The term K_{0.5}f^{0.5} reflects the contribution of skin effect losses to signal attenuation, which is proportional to the square root of signal frequency. The magnitude of coefficient K_{0.5} is a function of the structure, length and material characteristics of the transmission media.

The polynomial K₁f¹+K₂f²+ . . . +Kₙfⁿ reflects the contribution of dielectric absorption losses to signal attenuation. Coefficients K₁, K₂, K₃ . . . are functions of the structure, length and material characteristics of the transmission media. The higher order coefficients of the terms of the polynomial generally grow progressively smaller, and the number n of terms of the expression needed to model dielectric absorption losses depends on the required modeling accuracy. In most cases a value of n ranging from 1 to 3 will provide sufficient accuracy.

For some transmission media the values of coefficients K₀, K_{0.5}, K₁, K₂, . . . Kₙ can be calculated based on the physical characteristics of the media. It is also possible to experimentally determine the appropriate coefficient values by measuring attenuation by the media of signals having n+2 different signal frequencies. For example, if n=1, we can perform measurements at three known signal frequencies fₐ, f_{b}, and f_{c} to determine three attenuation values Aₐ, A_{b}, and A_{c}. We then write three equations in three unknowns
Aₐ=1/(K₀fₐ⁰+K_{0.5}fₐ^{0.5}+K₁fₐ¹)
A_{b}=1/(K₀f_{b}⁰+K_{0.5}f_{b}^{0.5}+K₁f_{b}¹)
A_{c}=1/(K₀f_{c}⁰+K_{0.5}f_{c}^{0.5}+K₁f_{c}¹)
and solve them for the three unknowns (K₀, K_{0.5}, K₂).
Digital Signal Distortion

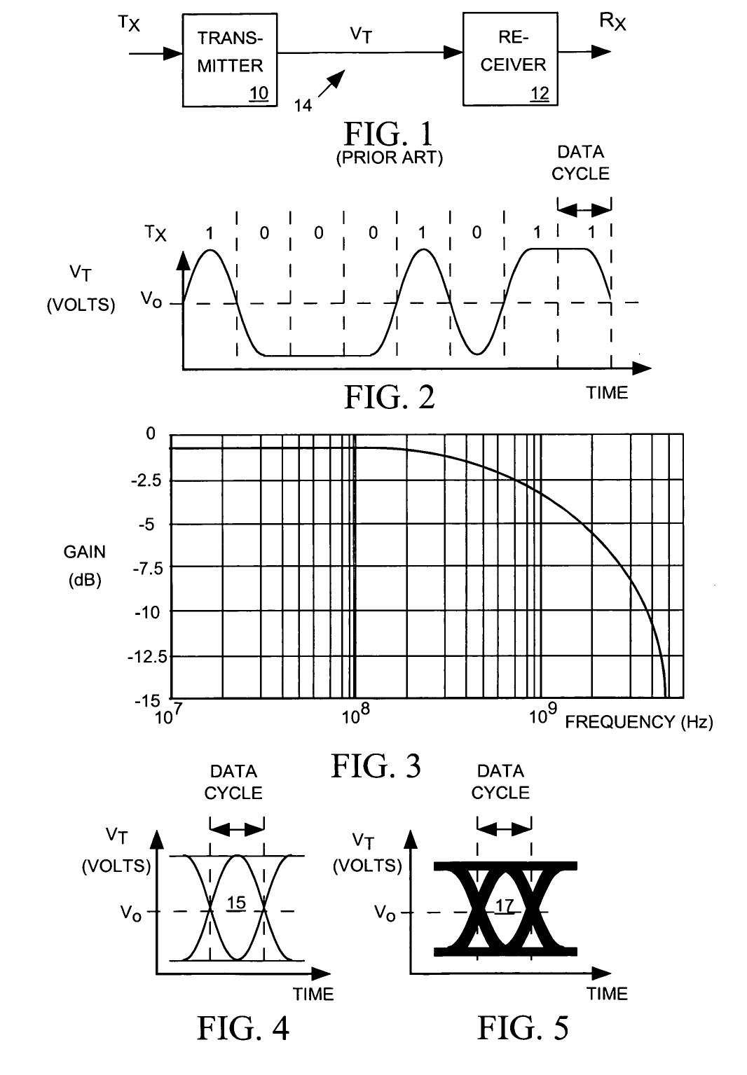

As illustrated in FIG. 2, a transmitter organizes a digital signal V_{T} into a succession of data cycles, each corresponding to a separate bit of a data sequence T_{X}. The voltage level of V_{T} during each data cycle is a symbol for the corresponding bit. In the example of FIG. 2, V_{T} represents a digital “1” during any cycle in which its voltage is above a reference level Vₒ and a digital “0” during any cycle in which its voltage is below Vₒ. The frequency spectrum of digital signal V_{T} depends not only on the period of its data cycle but also on the nature of the data sequence Tₓ the signal represents. Assume, for example, that the V_{T} signal has an 8 GHz data cycle. When it represents a data sequence including long sequences of all 0's and all 1's, such that V_{T} signal transitions occur at less than a 200 MHz rate, the signal can act like a low frequency signal that transmission media 14 attenuates very little. When the V_{T} signal represents a long alternating sequence of 1's and 0's {10101010 . . . } it can act like a 4 GHz sine wave that transmission media 14 greatly attenuates. When digital signal V_{T} represents a more random bit pattern, it behaves like a signal having several frequency components.

When a high frequency digital signal passes through transmission media having the frequency response shown in FIG. 3, the transmission media attenuates frequency components higher than about 2 GHz by substantially differing amounts. Such variation in attenuation distorts the signal not only by reducing the separation between the signal's high and low logic levels by varying amounts, but also by varying the relative timing during each data cycle of signal peaks and reference level crossings. These effects are sometimes called “intersymbol distortion” because the voltage level during one data cycle, which is a symbol for a data bit, can influence voltage levels during other data cycles. Intersymbol distortion, if severe enough, can cause a signal receiver to incorrectly determine the state of data bits the signal represents during some data cycles. Any reduction in separation of the signal's peaks reduces its signal-to-noise ratio, making it possible for smaller noise spikes to temporarily drive the signal to the wrong side of reference level Vₒ, thereby causing the receiver to misinterpret the state of a represented bit. While a receiver should sample the digital signal at a time during each data cycle at which the signal is at its peak, variation in signal timing (jitter) resulting from intersymbol distortion can cause the receiver to sample the signal other than at its peak during some data cycles, thereby lowering the signal's effective signal-to-noise ratio. Since signal distortion increases with signal frequency, there is a limit to the signal bandwidth that transmission media can accommodate while maintaining signal-to-noise ratio at an acceptable level. Since signal distortion also increases with transmission media length, there is a limit to the transmission media length that will permit an acceptable signal-to-noise ratio for a signal of a given bandwidth.

Compensation

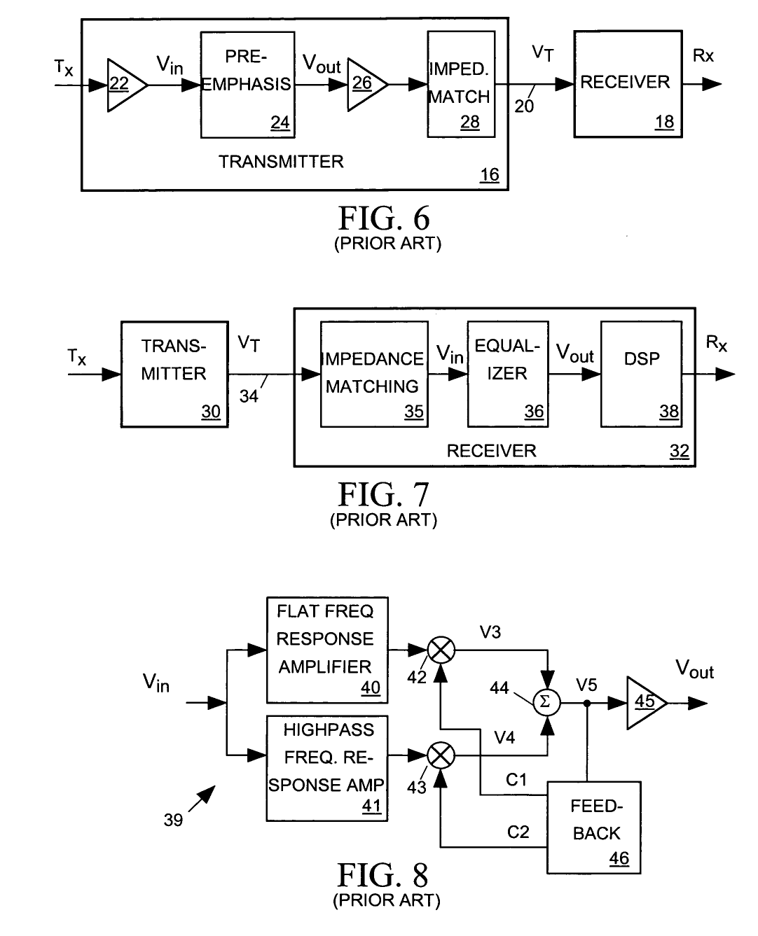

FIGS. 6 and 7 illustrate prior art data transmission systems in which a transmitter converts an input bit sequence Tₓ into a digital signal V_{T} it transmits to a receiver via transmission media. The receiver then processes the digital signal V_{T} to produce an output bit sequence Rx matching input bit sequence Tₓ. Each data transmission system increases the allowable length and/or bandwidth of transmission media by selectively boosting the various frequency components of the V_{T} signal to compensate for the signal distortion caused by the transmission media.

In a “pre-emphasis” system as illustrated in FIG. 6, signal transmitter 16 includes a pre-emphasis circuit 24 that compensates the V_{T} signal before sending it over transmission media 20. An amplifier 22 converts the T_{X} sequence into an input signal Vᵢₙ to pre-emphasis circuit 24 and another amplifier 26 amplifies the output signal Vₒᵤₜ of pre-emphasis circuit 24 to produce the V_{T} signal forwarded to transmission media 16 via an impedance matching circuit 20. In an “equalization” system as illustrated in FIG. 7, a signal receiver 32 compensates the V_{T} signal after it passes over the transmission media 34, but before processing it to extract the R_{X} data sequence. An impedance matching circuit 35 delivers the uncompensated V_{T} signal as an input signal Vᵢₙ to an equalizer 36 that compensates the Vᵢₙ signal for transmission media distortion to produce an output signal Vₒᵤₜ. Additional digital processing circuits 38 then processes the Vout signal to produce the R_{X} data sequence.

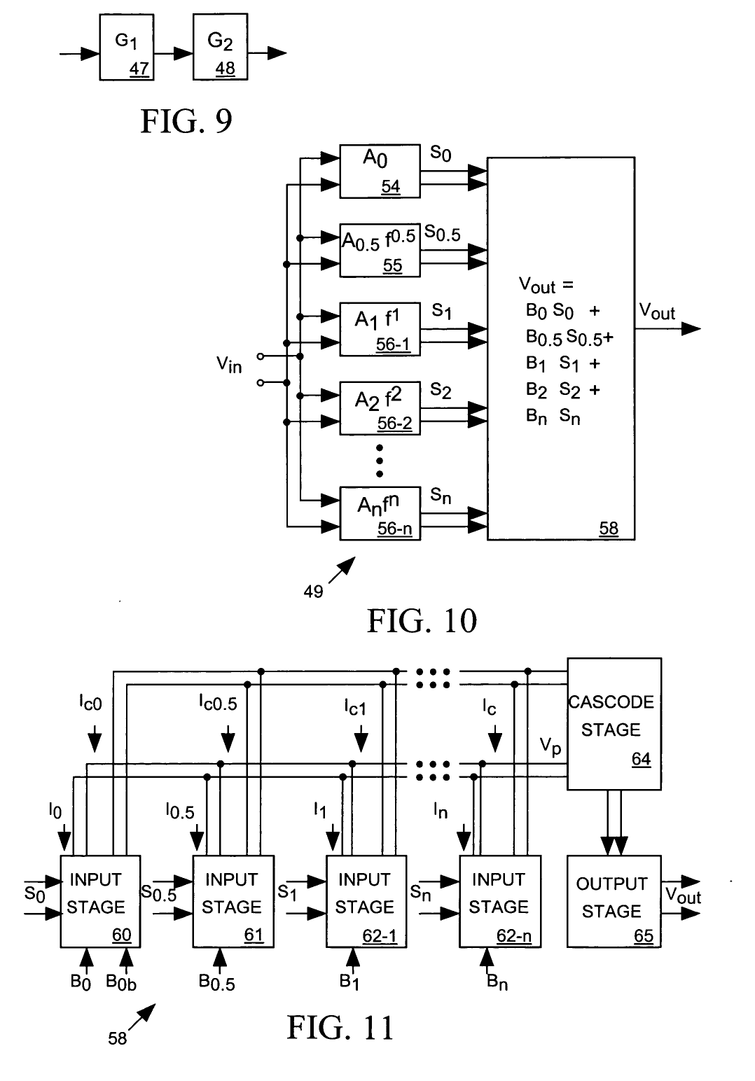

The voltage gain or loss of two circuits connected in series is multiplicative. For example as shown in FIG. 9 when circuits 47 and 48 having frequency dependant gain functions G₁ and G₂ are connected in series, the total gain is G₁*G₂. For a pre-emphasis system, the pre-emphasis circuit in the transmitter acts as circuit 47 and the transmission media acts as circuit 48. In such case, the gain G₂ of the transmission media is a function of frequency and is always negative for each frequency component because it attenuates all signal frequencies. In order best compensate for the transmission media attenuation, we would like the gain function G₁ of the pre-emphasis circuit 47 to be the inverse of the attenuation G₂ of the transmission media
G₁=1/G₂
so that they will cancel one another
G₁*G₂=0.
In such case the amount by which pre-emphasis circuit 47 amplifies any given frequency component of the signal would exactly offset the amount by which the transmission media attenuates that frequency component.

Similarly, for an equalization system, the equalizer in the receiver acts as circuit 48 and the transmission media acts as circuit 47. In such case the attenuation G1 of the transmission media is a function of frequency and is always negative for each frequency component. In order best compensate for the transmission media attenuation, we would like the gain G₂ of equalizer 47 to be the inverse of the attenuation G₁ of the transmission media
G₂=1/G₁
so that they will cancel one another.

As discussed above, the attenuation Gₜₗ of transmission media conveying a signal can be modeled by
Gₜₗ=1/(K₀f⁰+K_{0.5}f^{0.5}+K₁f¹+K₂f²+ . . . +Kₙfⁿ)
where coefficients K₀, K_{0.5} and K₁ . . . Kₙ are constants, f is the frequency of the signal and n is an integer at least as large as 1. Increasing the value of n increases model accuracy.

An equalizer or a pre-emphasis circuit in accordance with the invention therefore should have a compensating gain G_{c} such that
G_{c}*Gₜₗ=M
where M is a constant that is independent of frequency. Thus, for example, when n is 1 and M=0, the gain of the equalizer or a pre-emphasis circuit would be
G_{c}=K₀f⁰+K_{0.5}f^{0.5}+K₁f¹
When, for example, n=3, the compensating gain is
G_{c}=K₀f⁰+K_{0.5}f^{0.5}+K₁f¹+K₂f²+K₃f³
The larger the value of n, the more accurate the compensation. The compensating gain expression for non-zero values of M would have the same form as the above expression, but coefficient Kₒ would change in proportion to the value of M.

FIG. 10 is a block diagram depicting a circuit 49 in accordance with the invention that can act as either a pre-emphasis circuit or an equalizer for amplifying an input signal Vᵢₙ to produce a compensated output signal with gain G_{c}. Circuit 49 includes n+2 input circuits 54, 55 and 56-1 through 56-n. For each value of the set j={0, 0.5, 1, 2 . . . n) a corresponding one of the input circuits amplifies Vᵢₙ with a gain of Aⱼfⁱ to produce a separate differential output signal Sⱼ. An output circuit 58 comprising a prescaling summing amplifier amplifies each signal Sⱼ with a corresponding gain Bⱼ and sums the resulting signal to produce the Vₒᵤₜ signal. The values of all coefficients Aⱼ and Bⱼ are independently adjustable, and are suitably adjusted to satisfy the following relationships:
K₀=A₀B₀
K_{0.5}=A_{0.5}B_{0.5}
K₁=A₁B₁
K₂=A₂B₂
. . .
Kₙ=AₙBₙ
The gain of circuit 49 is
gain=K₀f⁰+K_{0.5}f^{0.5}+K₁f¹+K₂f²+ . . . +Kₙfⁿ.

FIG. 11 depicts an example implementation of output circuit 58 of FIG. 10 in more detailed block diagram form. Output circuit 58 includes a set of input stages 60, 61 and 62-1 through 62-n, each of which converts the voltage its corresponding one of input signals S₀, S_{0.5}, S₁, . . . Sₙ to a corresponding differential current (I₀, I_{0.5}, I₁, . . . Iₙ) and the input signal to each stage controls the relative magnitude of that stage's output differential current. Each input stage 60, 61 and 62-1 through 62-n, also produces a corresponding compensating current (I_{c0}, I_{c0.5}, I_{c1}, . . . I_{cn}) having magnitudes that are functions of the magnitude of the stage's corresponding gain control data B₀, B_{0.5}, B₁, . . . Bₙ and of the stage's S₀, S_{0.5}, S₁, . . . Sₙ. A cascode amplifier stage 66 produces a differential output voltage Vₚ in response to the output currents of all stages, and an output stage 60 produces the Vₒᵤₜ signal in response to Vₚ.

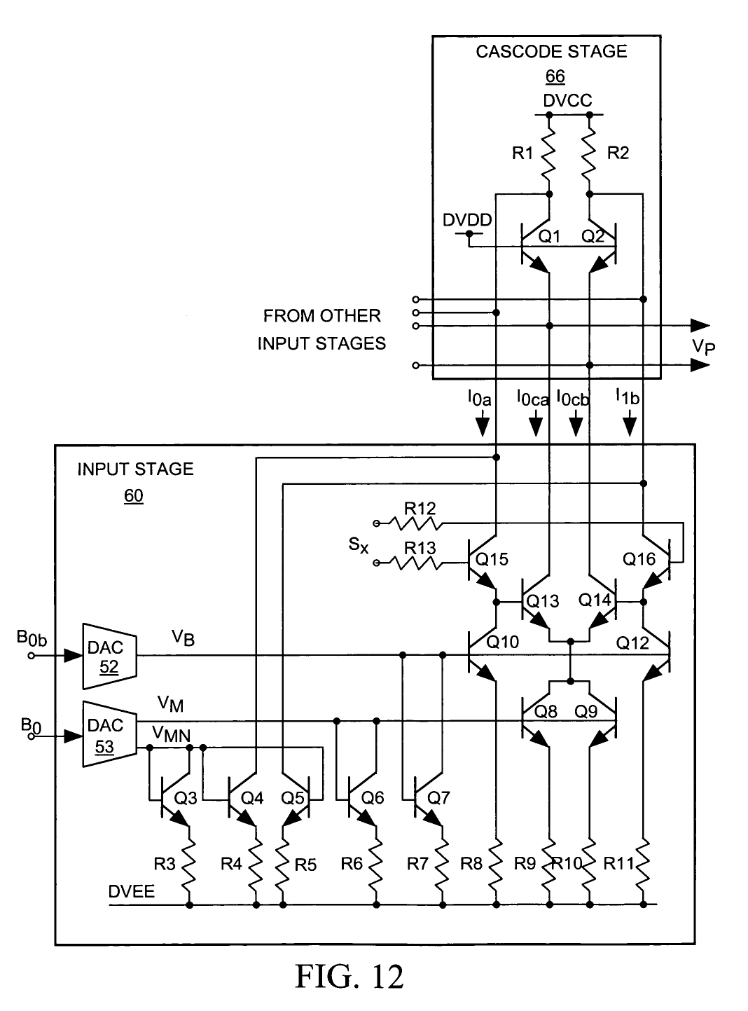

FIG. 12 depicts input stage 60 and cascode stage 66 of FIG. 11 in more detail. Stages 61 and 62-1 through 62-n are similar to stage 60. Cascode stage 66 includes transistors Q1 and Q2 and resistors R1 and R2 connecting the collectors of transistors Q1 and Q2 to a voltage source DVCC. A voltage source DVDD drives the bases of transistors Q1 and Q2. Cascode state 66 supplies an output signal Vₚ developed across resistors R1 and R2 that is proportional to a sum of currents produced by input stages 60, 61 and 62-1 through 62-n of FIG. 11.

Input stage 60 includes a set of transistors Q3-Q16, a pair of digital-to-analog converters (DACs) 52 and 53 and a set of resistors R3-R11 coupling a voltage source DVEE to the emitters of transistors Q3-Q12, respectively. Resistors R12 and R13 couple input signal S₀ to the bases of transistors Q15 and Q16. The emitters of transistors Q15 and Q16 are connected to the collectors of transistors Q10 and Q12, respectively, and emitters of transistors Q13 and Q14 are connected to the collectors of transistors Q8 and Q9. DAC 53 converts input gain control data B₀ to complementary voltage signals V_{M} and V_{MN}. Signal V_{M} drives the bases of transistors Q3-Q5, and the collector of transistor Q3. Signal V_{MN} drives the bases of transistors Q6, Q8 and Q9, and the collector of transistor Q8. DAC 52 converts input bias control data B_{0b} to a signal V_{B} for driving the bases of transistors Q7, Q10 and Q12 and the collector of transistor Q7.

Transistors Q10, Q12, Q15 and Q16 and resistors R7 and R11 form an emitter follower amplifier for controlling relative magnitudes of differential currents I₀ₐ and I_{0b} in response to input signal S₀. Transistors Q8, Q9, Q13 and Q14 and resistors R9 and R10 form a differential amplifier for producing differential compensating currents I_{c0a} and I_{c0b} in response to the bias voltage output of DAC 52. Transistors Q3-Q5 and resistors R3-R5 form a current mirror for providing output voltage compensation. Transistors Q7-Q9 and resistors R7, R10 and R11 for a current mirror providing gain control

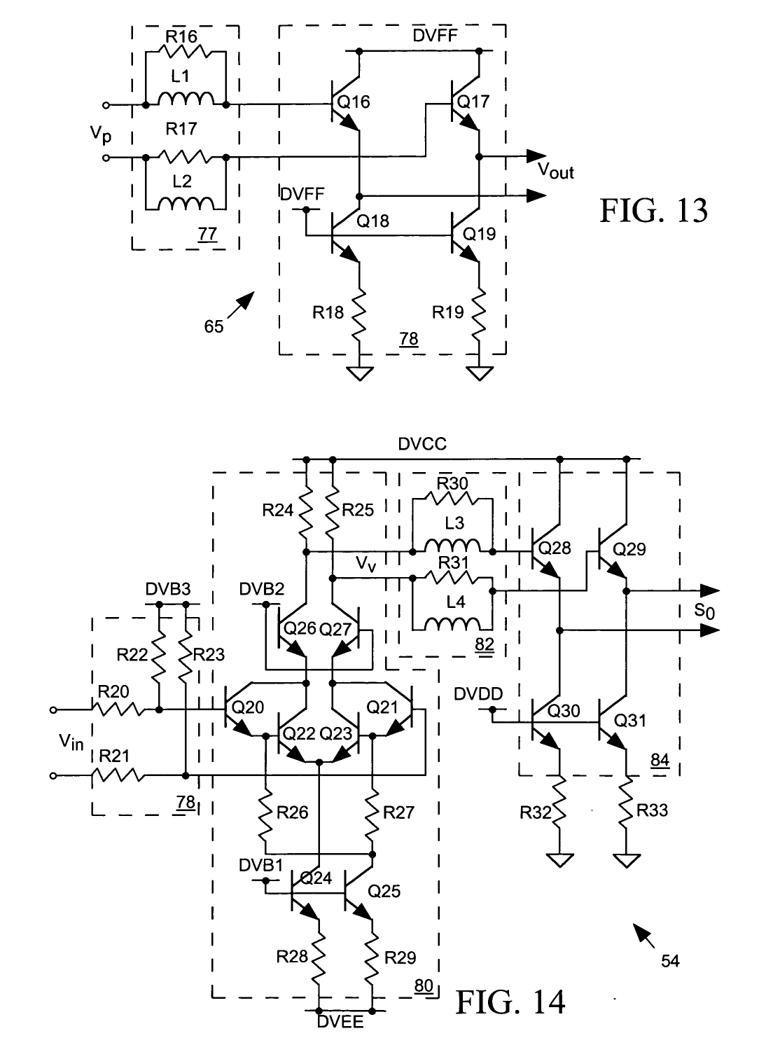

FIG. 13 depicts an example implementation of output stage 65 of circuit 58 of FIG. 11. Output stage 65 includes a peaking circuit 77 including inductors L1 and L2 and resistors R16 and R17 for leveling the frequency response of signal Vₚ to provide an input to a driver 78 formed by transistors Q16-Q19 and resistors R18 and R19 for producing the output signal Vₒᵤₜ. Inductors L1 and L2 and resistors R16 and R7 couple Vₚ across the bases of transistors Q16 and Q1. Collectors of transistors Q16 and Q17 and bases of transistors Q18 and Q19 are tied to voltage source DVFF. The emitter of transistor Q17 is coupled to ground through the collector-emitter path of transistor Q18 and resistor 18 while the emitter of transistor Q18 is coupled to ground through the emitter-collector path of transistor 19 and through resistor 19. Output signal Vₒᵤₜ appears across the collectors of transistors Q16 and Q17.

FIG. 14 depicts an example implementation of input circuit 54 of FIG. 10 for amplifying Vᵢₙ with a flat gain of A₀ to produce S₀. An attenuator 78 formed by resistors R20-R23 having a flat response couples Vᵢₙ to a differential amplifier 80 producing an output signal Vᵥ. A peaking circuit 82, formed by resistors R30 and R31 and inductors L3 and L4, couples the output of amplifier 80 to an output driver 84 producing output signal S₀. Amplifier 80 includes transistors Q20-Q27, resistors R24-R29, and transistors Q21-Q27. Resistors R20 and R21 couple Vᵢₙ to bases of transistors Q20 and Q21. Resistors R22 and R23 couple a source DVB3 to bases of transistors Q20 and Q21. Emitters of transistors Q20 and Q21 drive bases of differential transistor pair Q22 and Q23 and are connected to source DVEE through resistors R26 and R27, the collector-emitter path of transistors Q25 and resistor R29. The collector-emitter path of transistors Q24 and Q25 couple emitters of transistors Q22 and Q23 to DVEE. Resistors R24 and R25 and the collector-emitter paths of transistors Q26 and Q27 couple the collectors of transistors Q22 and Q23 to DVCC. A source DVB1 biases the bases of transistors Q24 and Q25, and a source DVB2 biases the bases of transistors Q26 and Q27. Output driver 84 includes transistors Q28 through Q31, and resistors R30 and R31. Filter 82 couples the output signal Vᵥ of amplifier across the bases of transistors Q28 and Q29, the collectors of which are tied to source DVCC. Output signal S₀ appears across the emitters of transistors Q28 and Q29. The collector-emitter path of transistors Q30 and resistor R32 couple the emitter of transistor Q28 to ground. The collector-emitter path of transistors Q31 and resistor R33 couple the emitter of transistor Q29 to ground. Source DVDD drives the bases of transistors Q30 and Q31.

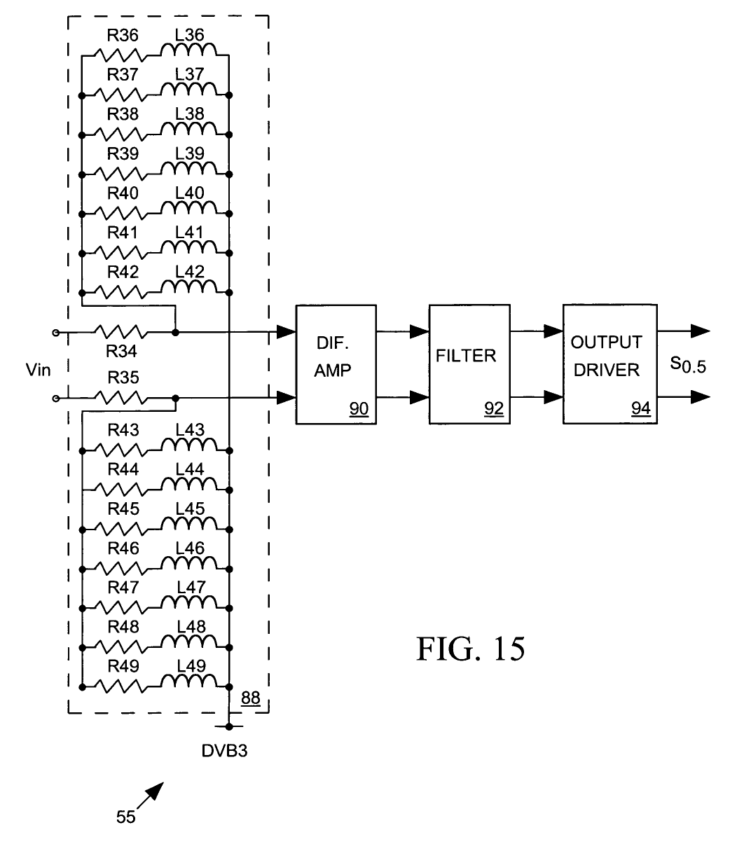

FIG. 15 depicts an example implementation of input circuit 55 of FIG. 10 for amplifying Vᵢₙ with gain proportional to the square root of the Vᵢₙ signal frequency to produce output signal S_{y}. Input circuit 55 includes a filter stage 88 formed by resistors R34-R49 and inductors L36-L49 having a frequency response that is proportional to the square root of the Vᵢₙ signal frequency to supply an input signal to a differential amplifier 90 similar to amplifier 80 of FIG. 12 . A peaking circuit 92, similar to peaking circuit 82 of FIG. 14, couples the output of differential amplifier 90 to the input of an output driver 94 similar to driver 84 of FIG. 14. Driver 94 produces output signal S_{0.5}.

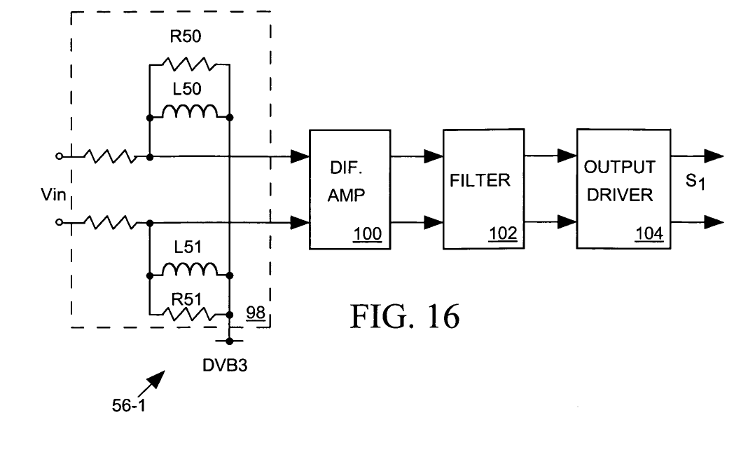

FIG. 16 depicts an example implementation of input circuit 56-1 of FIG. 10 for amplifying Vᵢₙ with gain proportional to the Vᵢₙ signal frequency to produce output signal S₁. Input circuit 56-1 includes a filter stage 98 formed by resistors R50 and L50 and inductors L50-L51 having a frequency response proportional to Vᵢₙ signal frequency to supply an input signal to a differential amplifier 100 similar to amplifier 80 of FIG. 14 . A peaking circuit 102, similar to peaking circuit 82 of FIG. 14, couples the output of differential amplifier 100 to the input of an output driver 104 similar to driver 84 of FIG. 14. Driver 104 produces output signal S₁.

Those of skill in the art will appreciate that input circuits 56-2 through 56-n of FIG. 10 may be generally similar in design to input 56-1 of FIG. 16 with filter 102 modified as necessary to provide the appropriate frequency response.

In the preferred embodiment of the invention, the gain of a pre-emphasis or equalizing compensation circuit is:
gain=K₀f⁰+K_{0.5}f^{0.5}+K₁f^{f}+K₂f²+ . . . +Kₙfⁿ [1]

As discussed above, a compensation circuit implementing this includes a separate filter for each term of expression [1] and a summing amplifier for summing the outputs of the filter. For a typical transmission media, the K₀ and K_{0.5}f^{0.5} terms model attenuation due to DC and skin effect losses in a typical transmission media, respectively, and the polynomial (K₁f¹+K₂f²+ . . . +Kₙfⁿ) models attenuation due to dielectric absorption losses. Generally the larger the number (n) of terms in the polynomial, the more accurate the compensation, but in most applications n need not exceed 2 or 3 to provide satisfactory compensation.

From a mathematical standpoint, a compensation circuit having a gain that is a pure polynomial in f of the form
gain=K₀f⁰+K₁f¹+K₂²+ . . . +Kₙfⁿ [2]
can compensate for transmission media losses just as well as a pre-emphasis or equalizing circuit having the gain of expression [1]. Note that expressions [1] and [2] are similar except that expression [2] omits the term K_{0.5}f^{0.5}. In most applications, the drawback to employing a compensation circuit having the gain of expression [2], is that it will normally require many more terms in its gain polynomial than a compensation circuit of the form of expression [1] in order to obtain an equivalent level of compensation accuracy. Since attenuation due to skin effect losses are proportional to f^{0.5}, expression [1] directly models those losses with a single term K_{0.5}f^{0.5} suitably implemented by a single filter. Lacking the K_{0.5}f^{0.5} term, expression [2] must model skin effect losses using a truncated version of an infinite series to give comparable results, and a compensating circuit implementing expression [2] would require more circuitry implementing a greater number of terms than a compensating circuit implementing expression [1].

Thus while it is possible to construct a compensation circuit having the gain of expression [2], such a compensation circuit would normally be more hardware intensive than a compensation circuit having the gain of expression [1] in most applications. However in some applications, such as for example in compensating for losses in superconductors, where skin effect losses are normally negligible, the compensating circuit of FIG. 10 can be adapted to implement the gain expression of expression [2] by omitting filter 55.

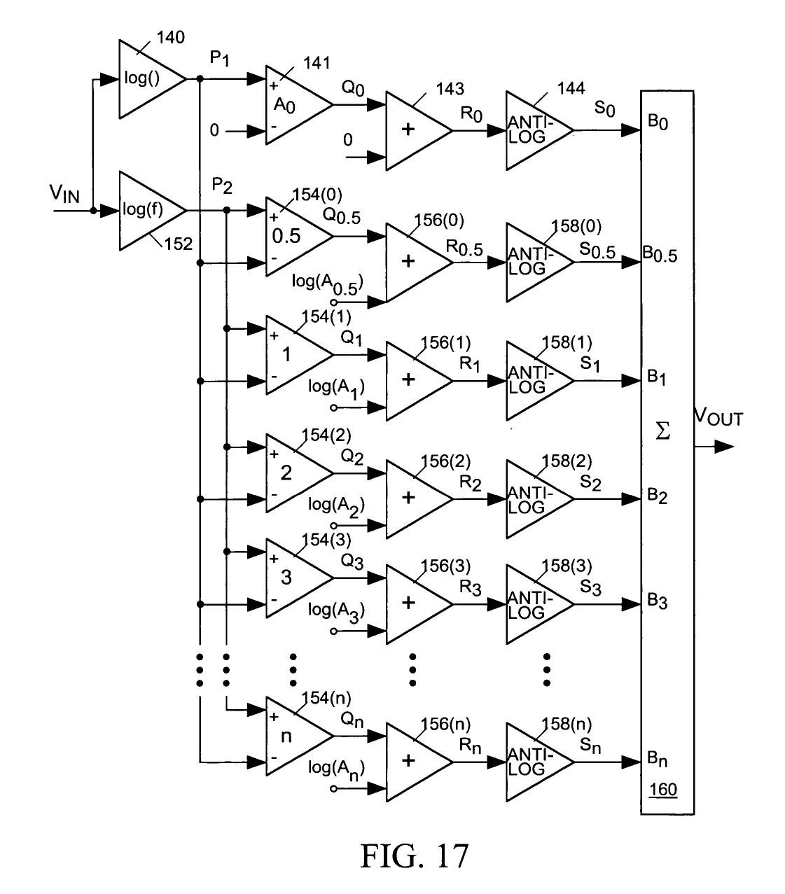

FIG. 17 depicts an alternative embodiment of a pre-emphasis or equalizing compensation circuit in accordance with the invention providing a gain implementing expression [1] above. A logarithmic amplifier 140 amplifies input signal V_{IN} to produce an output signal
V₁=log(Vᵢn).
An amplifier 141 amplifies V₁ with a gain of A₀ to produce a signal Q₀. A summing amplifier 143 sums Qₒ with 0 to produce an output signal R₀, and an antilog amplifier 144 amplifies R₀ to produce an output signal
S₀=antilog(R₀)
A logarithmic frequency amplifier 152 amplifies input signal V_{IN} to produce an output signal
V₂=log(fVᵢₙ)
For each value of j of the set j={0.5, 1, 2, 3 . . . n):

1. a separate one of a set of n+1 amplifiers 154(0)-154(n) subtracts V₁ from V₂ and amplifies the result with gain j to produce an output signal Qⱼ,

2. a separate one of a set of n+1 summing amplifiers 156(0)-156(n) sums each signal Qⱼ with a signal of magnitude log(Aⱼ) to produce an output signal R, and

3. a separate one of a set of n+1 anti-log amplifiers 158(0)-158(n) amplifies each signal Rⱼ to produce an output signal Sⱼ=antilog(Rᵢ).

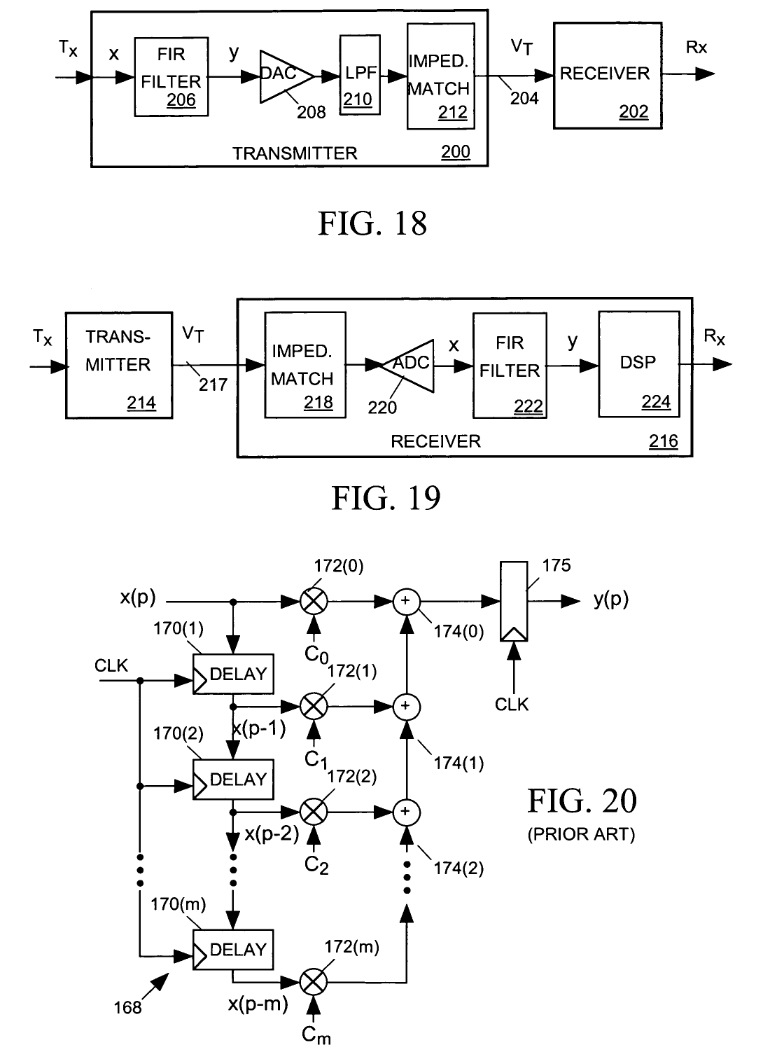

A prescaling summing amplifier 160 amplifies each signal Sⱼ with a separate gain Bⱼ and sums the resulting signals to produce output signal Vₒᵤₜ. For each value of j, at least one of constants Aⱼ and Bⱼ is independently adjustable, and adjusted to satisfy the relationships
K₀=A₀B₀
K_{0.5}=A_{0.5}B_{0.5}
K₁=A₁B₁
K₂=A₂B₂
. . .
Kₙ=AₙBₙ
such that the gain of the circuit of FIG. 18 is
gain=K₀j⁰+K_{0.5}f^{0.5}+K₁f¹+K₂f²+ . . . +Kₙfⁿ
consistent with expression [1] above.
When amplifiers 154(0), 156(0) and 158(0) are omitted from the circuit of FIG. 18, its overall gain is
gain=K₀f⁰+K₁f¹+K₂f²+ . . . +Kₙfⁿ
consistent with expression [2] above.
Compensation Using an FIR Filter

Pre-emphasis or equalization can also be provided by a digital or analog finite impulse response (FIR) filter in accordance with the invention within a transmitter or a receiver.

FIG. 18 illustrates a data transmission system including a transmitter 200 for converting input data T_{X} defining an analog output signal V_{T} transmitted to a receiver 202 via transmission media 204. In transmitter 200, the Tₓ data is supplied as a data sequence input x(i) to a digital filter 206 producing output data sequence y(i) re-defining the V_{T} signal so as to compensate it for distortion in transmission media 204. A digital-to-analog converter (DAC) 208 and a low pass filter (LPF) 210 convert the y(i) data sequence into an analog signal V_{T} forwarded through an impedance matching circuit 212 to transmission media 204.

FIG. 19 illustrates a data transmission system including a transmitter 214 for converting input data T_{X} defining an analog output signal V_{T} transmitted to a receiver 216 via transmission media 217. In receiver 216, an impedance matching circuit 218 applies the V_{T} signal as input to an analog-to-digital converter (ADC) 220 supplying an output sequence x(i) representing V_{T} as input to a digital filter 222. Digital filter 222 acts as an equalizer, processing the x(i) sequence to produce an output sequence y(i) representing an equalized version of the V_{T} input to receiver 216. Additional conventional digital signal processing circuits 224 processes the y(i) sequence to produce output sequence Rₓ.

As illustrated in FIG. 20, an appropriately programmed conventional m+1 tap digital FIR filter 168 could be employed either as digital filter 206 of FIG. 18 or as digital filter 222 of FIG. 19. The number of taps m+1 is an integer greater than 1. Generally the more taps, the more accurately the filter is able to approximate the desired transfer function. Filter 168 includes a series of delay elements 170(1) . . . 170(m) such as registers clocked by a clock signal (CLK) indicating when each input data sample x(i) is valid. Each k^{th} delay element 170(k) delays its input data by one CLK cycle to produce output data x(i−k). For each value of k=0 to m, a separate multiplier 172(k) multiplies x(i−k) by Cₖ. A set of summers 174(0) through 174(m−1) sum the outputs of multipliers 172(0) through 172(k) to produce an input to a latch 175 clocked by the CLK signal to produce output data sequence y(i).

Digital filter 168 has a transfer function of the form
y(i)=C₀x(i)+C₁x(i−1)+C₂x(i−2)+ . . . Cₘx(i−m)
where x(p) is the p^{th} sample of an input data sequence x representing the signal to be compensated and y(p) is the p^{th} element of an output data sequence representing the compensated signal. This transfer function can also be expressed in the form
y/x=C₀+C₁z⁻¹+C₂z⁻²+C₃z⁻³ . . . Cₘz^{-m} [3]
where z⁻¹ is the unit delay function. Assuming that filter 168 is to approximate a compensating frequency response of the form
F(f)=K₀+K₁f+K₂f²+K₃f³+ . . . [4]
where f is signal frequency and {K₀, K₁, K₂, K₃ . . . } are constants, it is necessary to choose the proper values for the tap coefficients C₀-Cₘ. It is known to compute the necessary values of the digital filter transfer coefficients of transfer function [3] by first creating a Fourier series approximation of the frequency response function and then equating the series coefficients with the transfer function coefficients. Various refinements known to those of skill in the art such as windowing functions and phase correction can be applied to improve the accuracy of coefficient computation. It is also normally possible to employ successive Laplace and Z transforms to convert the frequency response function into the filter transfer function.

Although any desired frequency response can be expressed as a polynomial of frequency as in expression [4] above, the number of terms needed to accurately compensate for typical transmission media distortion including skin effect attenuation is typically much larger than the number of terms needed when the frequency response function is expressed in the following form:
F(f)=K_{0.5}f^{0.5}+K₀+K₁f+K₂f²+K₃f³+ . . . [5]
which can be approximated by a digital filter having the following transfer function:
y/x=C_{0.5}z^{-0.5}+C₀+C₁z⁻¹+C₂z⁻²+C₃z⁻³ . . . Cₘz^{-m} [6].

Referring to FIG. 20, the conventional FIR filter 168 is not adapted for efficiently implementing the C_{0.5}z^{-0.5} term because, lacking the ability to directly compute the term C_{0.5}f_{0.5}, it would require a large number of taps to accurately represent the term.

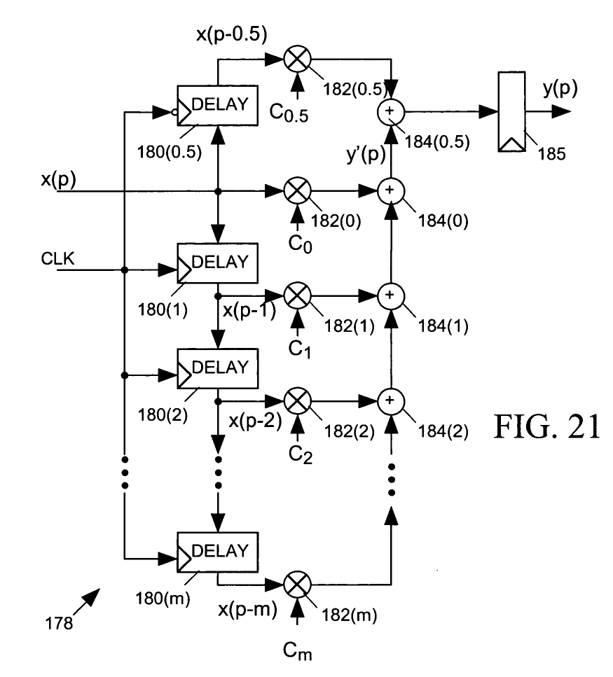

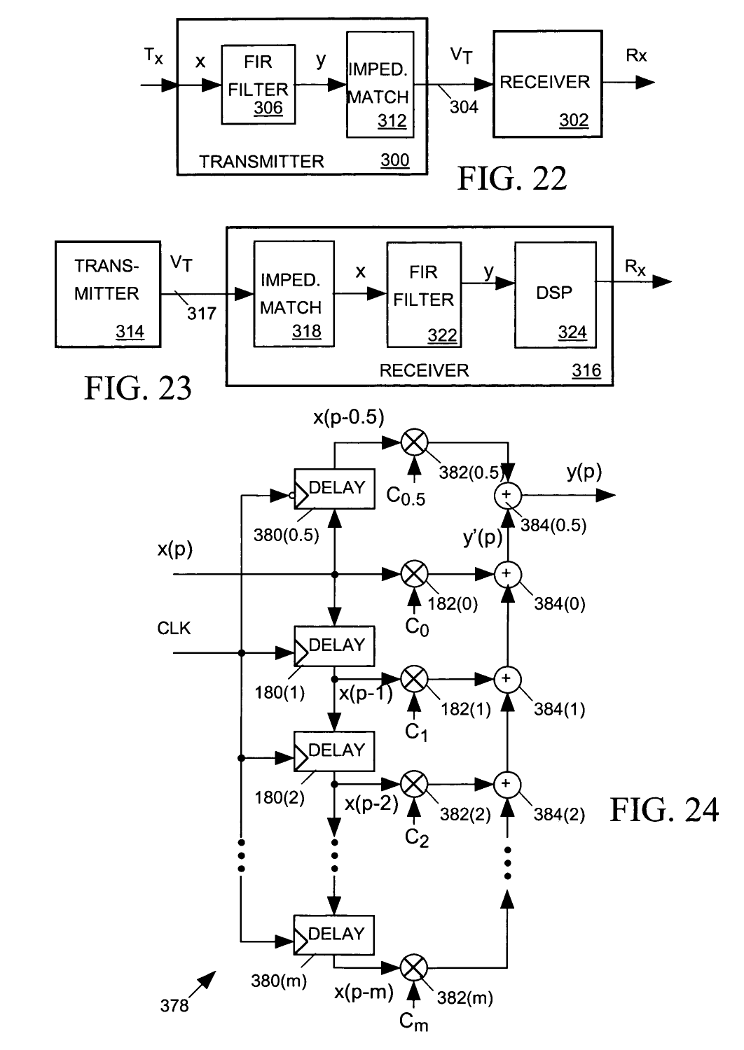

FIG. 21 depicts a digital FIR filter 178 in accordance with the invention, suitable for use as FIR filter 206 or 222 of FIG. 18 or 19, that does implement the C_{0.5}z^{0.5} term. Each i^{th} input data sequence sample x(p) provides an input to a series of delay elements 180(1) . . . 180(m) clocked by the leading edge of clock signal CLK, and each k^{th} delay element 180(k) delays its input data by one CLK signal cycle to provide output data x(p−k). For each value of k=0 to m, a separate multiplier 172(k) multiples x(p−k) by Cₖ. A set of summers 184(0) through 184(m−1) sum the outputs of multipliers 182(0) through 182(m) to produce a data value y′(i). An additional delay element 180(0.5), clocked on the trailing edge of clock signal CLK, delays data element x(p) by one half cycle of the CLK signal to produce output data element x(p−0.5). Multiplier 182(0.5) multiplies x(p−0.5) by C_{0.5} and a summer 184(0.5) sums the result with y′(p) to produce output data latched by latch 185 clocked at twice the CLK signal frequency to produce output sequence y(p).

FIG. 22 illustrates a data transmission system including a transmitter 300 for converting input data T_{X} defining an analog output signal V_{T} transmitted to a receiver 302 via transmission media 304. In transmitter 300, an analog Tₓ data signal is supplied as an input signal x(i) to an analog FIR filter 306 producing an analog output signal y(i) forwarded through an impedance matching circuit 312 as the V_{T} input signal to transmission media 304.

FIG. 23 illustrates a data transmission system including a transmitter 314 for converting input data T_{X} defining an analog output signal V_{T} transmitted to a receiver 316 via transmission media 317. In receiver 316, an impedance matching circuit 318 couples the V_{T} signal an input signal x to an analog FIR filter 322. Filter 322 acts as an equalizer, processing input signal x to produce an output signal y as an equalized version of the V_{T} input to receiver 316. Additional digital signal processing circuits 324 process filter output signal y to produce output sequence Rₓ

FIG. 24 depicts an analog FIR filter 378 in accordance with the invention, suitable for use as FIR filter 306 or 322 of FIG. 22 or 23, that directly implements the C_{0.5}z^{-0.5} term. The analog x signal is applied as input to a series of delay elements 380(1) . . . 380(m) clocked by the leading edge of clock signal CLK, and each k^{th} delay element 380(p) delays its input signal by one CLK signal cycle to provide output data x(p−k). For each value of k=0 to m, a separate multiplier 372(k) multiples x(p−k) by Cₖ. A set of summers 384(0) through 384(m−1) sum the outputs of multipliers 382(0) through 382(m) to produce an analog signal y′. An additional delay element 380(0.5), clocked on the trailing edge of clock signal CLK, delays the x(p) signal by one half cycle of the CLK signal to produce output signal x(i−0.5). Multiplier 382(0.5) multiplies x(p−0.5) by C_{0.5} and a summer 384(0.5) sums the result with y′(p) to produce output signal y(p).

When applied to the frequency response expression [5], conventional approaches for computing filter tap coefficients C₀, C₁, . . . Cₘ of the digital and analog FIR filters of FIGS. 21 and 25 under the assumption that K_{0.5}=0, as would be the case when the transmission media has no skin effect losses. For more typical transmission media exhibiting skin effect losses that render K_{0.5} nonzero, tap coefficient C_{0.5} is suitably set to
C_{0.5}=K_{0.5}/(2π)^{0.5}.
In some cases an analytical solution for coefficients C_{0.5}, C₀, C₁ . . . Cₘ can be obtained using conventional mathematical techniques, including variable transformation based upon Z transforms including the square root of z or the square root of algebraic functions of z whose corresponding time domain functions are Bessel and Hankel functions.

The claims appended to this specification particularly point out and distinctly claim the subject matter of the invention. Although an example of the invention described above includes numerous details in order to provide a thorough understanding of that particular mode of practicing the invention, it will be apparent to those of skill in the art that other modes of practicing the invention recited in the claims need not incorporate such details. For example, while the drawings illustrate example implementations of various components of the invention having particular circuit topologies, those of skill in the art will appreciate that such components could be implemented using other circuit topologies to achieve similar functionality.

1. An apparatus for compensating a signal for attenuation in transmission media, the apparatus comprising a circuit for amplifying the signal with a gain proportional to a sum of a plurality of terms,
wherein the plurality of terms comprises a set of terms {K₀f⁰, K₁f¹, K₂f², . . . Kₙfₙ}
wherein n is an integer larger than 0,
wherein f is input signal frequency, and
wherein coefficients K₀, K₁, K₂, . . . Kₙ are independently adjustable constants that are adjusted to compensate for the attenuation in the transmission media.

2. The apparatus in accordance with claim 1, wherein the plurality of terms further comprises a term K_{0.5}f^{0.5}, wherein coefficient K_{0.5} is an independently adjustable constant.

3. The apparatus in accordance with claim 2 wherein coefficient K₀ is adjusted so that the term K₀f⁰ compensates for DC attenuation of the transmission media.

4. The apparatus in accordance with claim 2 wherein coefficient K_{0.5} is adjusted so that the term K_{0.5}f^{0.5} compensates for skin effect attenuation of the transmission media.

5. The apparatus in accordance with claim 2 wherein each j^{th} coefficient Kⱼ for j=1 though n, is adjusted so that a sum of terms of a set {K₁f¹, K₂f², . .. Kₙfⁿ} compensates for dielectric absorption loss attenuation of the transmission media.

6. The apparatus in accordance with claim 2
wherein coefficient K₀ is adjusted so that the term K₀f⁰ compensates for DC attenuation of the transmission media,
wherein coefficient K_{0.5} is adjusted so that the term K_{0.5}f^{0.5} compensates for skin effect attenuation of the transmission media, and
wherein each j^{th} coefficient Kⱼ for j=1 though n, is adjusted so that a sum of terms of the set of terms {K₁f¹, K₂f², . . . Kₙfⁿ} compensates for dielectric absorption loss attenuation of the transmission media.

7. The apparatus in accordance with claim 2 wherein the circuit processes the signal before the transmission media conveys it.

8. The apparatus in accordance with claim 2 wherein the circuit processes the signal after the transmission media conveys it.

9. The apparatus in accordance with claim 2 wherein the circuit comprises:
n+2 input circuits, one for each value of j in the set j={0, 0.5, 1, 2 . . . n}, wherein each j^{th} stage amplifies the input signal by a separate constant Aⱼ to produce a separate signal Sⱼ, and
an output circuit for receiving the output signals of the n+2 input circuits and producing the output signal (Vₒᵤₜ), wherein the output signal is proportional to
B₀S₀+B_{0.5}S_{0.5}+B₁S₁+B₂S₂+ . . . BₙSₙ
wherein coefficients B₀, B_{0.5}, B₁, B₂ . . . Bₙ are independently adjustable constants.

10. The apparatus in accordance with claim 9 wherein each constant Aⱼ is independently adjustable.

11. The apparatus in accordance with claim 9 wherein the output circuit comprises:
n+2 input stages, one for each value of j of the set j={0, 0.5, 1, 2 . . . n}, each producing a differential current that is proportional to BⱼSⱼ, and
a cascode stage for producing a cascode stage output signal (Vₚ) of amplitude proportional to a sum of differential currents produced by the input stages.

12. The apparatus in accordance with claim 11 wherein the output circuit further comprises an output stage for amplifying the cascode stage output signal (Vₚ) to produce the output signal (Vₒᵤₜ).

13. The apparatus in accordance with claim 11
wherein the cascode stage output signal (Vₚ) is a differential signal having a common mode voltage,
wherein each j^{th} input stage also produces a differential compensating current (I_{jc}) that is proportional to BⱼSⱼ, and
wherein the cascode stage also controls the common mode voltage of the cascode stage output signal in response to the differential compensating currents produced by the n+2 input stages.

14. The apparatus in accordance with claim 2 wherein the circuit comprises:
a first circuit for processing the input signal V_{IN} to produce a signal P₁ wherein
P₁=log(Vᵢₙ).
a second circuit for amplifying signal P₁ with a gain of A₀ to produce a signal Q₀, for summing Qₒ with 0 to produce a signal R₀, and amplifying signal R₀ to produce a signal S₀=antilog(R₀)
a third circuit for amplifying the input signal (V_{IN}) to produce a signal P₂=log(fVᵢₙ),
for each value of j of the set j={0.5, 1, 2, 3 . . . n), a separate fourth circuit for subtracting signal P₁ from P₂, for amplifying a result with gain j to produce a signal Qⱼ, for summing signal Qⱼ with a signal of magnitude log(Aⱼ) to produce a signal R, and for processing signal Rⱼ to produce a signal Sᵢ=antilog(Rᵢ); and
a fifth circuit for amplifying each signal Sⱼ with a separate gain Bⱼ and summing resulting signals to produce the output signal Vₒᵤₜ.
wherein for each value of j of the set j={0, 0.5, 1, 2, 3 . . . n), Aⱼ and Bⱼ are constants, at least one of which is adjustable.

15. The apparatus in accordance with claim 1 wherein the circuit amplifies the signal before the transmission media conveys it.

16. The apparatus in accordance with claim 1 wherein the circuit amplifies the signal after the transmission media conveys it.

17. The apparatus in accordance with claim 1 wherein the circuit comprises:
n+1 input circuits, one for each value of j in the set j={0, 1, 2 . . . n}, wherein each j^{th} stage amplifies the input signal by a separate constant Aⱼ to produce a separate signal Sⱼ, and
an output circuit for receiving the output signals of the n+1 input circuits and producing the output signal (Vₒᵤₜ), wherein the output signal is proportional to
B₀S₀+B₁S₁+B₂S₂+ . . . BₙSₙ
wherein coefficients B₀, B₁, B₂ . . . Bₙ are independently adjustable constants.

18. The apparatus in accordance with claim 17 wherein each constant Aⱼ is independently adjustable.

19. The apparatus in accordance with claim 17 wherein the output circuit comprises:
n+1 input stages, one for each value of j of the set j={0, 1, 2 . . . n}, each producing a differential current that is proportional to BⱼSⱼ, and
a cascode stage for producing a cascode stage output signal (Vₚ) of amplitude proportional to a sum of differential currents produced by the input stages.

20. The apparatus in accordance with claim 19 wherein the output circuit further comprises an output stage for amplifying the cascode stage output signal (Vₚ) to produce the output signal (Vₒᵤₜ).

21. The apparatus in accordance with claim 19
wherein the cascode stage output signal (Vₚ) is a differential signal having a common mode voltage,
wherein each j^{th} input stage also produces a differential compensating current (I_{jc}) that is proportional to BⱼSⱼ, and
wherein the cascode stage also controls the common mode voltage of the cascode stage output signal in response to the differential compensating currents produced by the n+1 input stages.

22. The apparatus in accordance with claim 1 wherein the circuit comprises:
a first circuit for processing the input signal V_{IN} to produce a signal P₁ wherein
Pᵢ=log(Vᵢₙ).
a second circuit for amplifying signal P₁ with a gain of A₀ to produce a signal Q₀, for summing Qₒ with 0 to produce a signal R₀, and amplifying signal R₀ to produce a signal S₀=antilog(R₀)
a third circuit for amplifying the input signal (V_{IN}) to produce a signal P₂=log(fVᵢₙ),
for each value of j of the set j={1, 2, 3 . . . n), a separate fourth circuit for subtracting signal P₁ from P₂, for amplifying a result with gain j to produce a signal Qⱼ, for summing signal Qⱼ with a signal of magnitude log(Aⱼ) to produce a signal R, and for processing signal Rⱼ to produce a signal Sᵢ=antilog(Rᵢ); and
a fifth circuit for amplifying each signal Sⱼ with a separate gain Bⱼ and summing resulting signals to produce the output signal Vₒᵤₜ.
wherein for each value of j of the set j={0, 1, 2, 3 . . . n), Aⱼ and Bⱼ are constants, at least one of which is adjustable.

23. A method for compensating a signal for attenuation in transmission media, the apparatus comprising the steps of amplifying the signal with a gain proportional to a sum of a plurality of terms,
wherein the plurality of terms comprises a set of terms {K₀f⁰, K₁f¹, K₂f², . . . Kₙfⁿ}
wherein n is an integer larger than 0,
wherein f is input signal frequency, and
wherein coefficients K₀, K₁, K₂, . . . Kₙ are independently adjustable constants that are adjusted to compensate for the attenuation in the transmission media.

24. The method in accordance with claim 23, wherein the plurality of terms further comprises a term K_{0.5}f^{0.5}, wherein coefficient K_{0.5} is an independently adjustable constant.

25. The method in accordance with claim 24 further comprising the step of
adjusting coefficient K₀ so that the term K₀f⁰ compensates for DC attenuation of the transmission media.

26. The method in accordance with claim 24 further comprising the step of
adjusting coefficient K_{0.5} so that the term K_{0.5}f^{0.5} compensates for skin effect attenuation of the transmission media.

27. The method in accordance with claim 24 further comprising the step of
adjusting each j^{th} coefficient Kⱼ for j=1 though n so that a sum of terms of a set {K₁f¹, K₂f², . . . Kₙfⁿ} compensates for dielectric absorption loss attenuation of the transmission media.

28. The method in accordance with claim 24 further comprising the steps of:
adjusting coefficient K₀ is adjusted so that the term K₀f⁰ compensates for DC attenuation of the transmission media,
adjusting coefficient K_{0.5} so that the term K_{0.5}f^{0.5} compensates for skin effect attenuation of the transmission media, and
adjusting each j^{th} coefficient Kⱼ for j=1 though n so that a sum of terms of the set of terms {K₁f¹, K₂f², . . . Kₙfⁿ} compensates for dielectric absorption loss attenuation of the transmission media.

29. The method in accordance with claim 24 wherein the step of amplifying the signal with a gain proportional to a sum of a plurality of terms comprises the substeps of:
for each value of j in the set j={0, 0.5, 1, 2 . . . n}, amplifying the input signal by a separate constant Aⱼ to produce a separate signal Sⱼ, and
processing signals Sⱼ, for all values of the set j={0, 0.5, 1, 2 . . . n} to produce the output signal (Vₒᵤₜ) proportional to
B₀S₀+B_{0.5}S_{0.5}+B₁S₁+B₂S₂+ . . . BₙSₙ
wherein coefficients B₀, B_{0.5}, B₁, B₂ . . . Bₙ are independently adjustable constants.

30. The method in accordance with claim 29 wherein each constant Aⱼ is independently adjustable.

31. The method in accordance with claim 29 wherein the step of processing signals Sⱼ, for all values of the set j={0, 0.5, 1, 2 . . . n} to produce the output signal (Vₒᵤₜ) comprises the substeps of:
for each value of j of the set j={0, 0.5, 1, 2 . . . n}, producing a differential current Iⱼ that is proportional to BⱼSⱼ, and
producing a signal Vₚ of amplitude proportional to a sum of differential currents Iⱼ for each value of j of the set j={0, 0.5, 1, 2 . . . n}.

32. The method in accordance with claim 31 wherein the step of processing signals Sⱼ, for all values of the set j={0, 0.5, 1, 2 . . . n} to produce the output signal (Vₒᵤₜ) further comprises the substep of:
amplifying the cascode stage output signal (Vₚ) to produce the output signal (Vₒᵤₜ).

33. The method in accordance with claim 31 wherein signal Vₚ is a differential signal having a common mode voltage, and wherein the step of processing signals Sⱼ, for all values of the set j={0, 0.5, 1, 2 . . . n} to produce the output signal (Vₒᵤₜ) further comprises the substeps of:
for each value of the set j={0, 0.5, 1, 2 . . . n} producing a differential compensating current I_{jc} that is proportional to BⱼSⱼ, and
controlling the common mode voltage of the cascode stage output signal in response to the differential compensating currents I_{jc} for each value of the set j={0, 0.5, 1, 2 . . . n}

34. The method in accordance with claim 24 wherein the step of amplifying the signal with a gain proportional to a sum of a plurality of terms comprises the substeps of:
processing the input signal V_{IN} to produce a signal P₁ wherein
P₁=log (Vᵢₙ).
amplifying signal P₁ with a gain of A₀ to produce a signal Q₀,
summing Qₒ with 0 to produce a signal R₀,
amplifying signal R₀ to produce a signal S₀=antilog(R₀)
amplifying the input signal (V_{IN}) to produce a signal P₂=log(fVᵢₙ),
for each value of j of the set j={0.5, 1, 2, 3 . . . n),
subtracting signal P₁ from P₂, for amplifying a result with gain j to produce a signal Qⱼ,
summing signal Qⱼ with a signal of magnitude log(Aⱼ) to produce a signal R, and
processing signal Rⱼ to produce a signal Sᵢ=antilog(Rᵢ); and
amplifying each signal Sⱼ with a separate gain Bⱼ and summing resulting signals to produce the output signal Vₒᵤₜ.
wherein, for each value of j of the set j={0, 0.5, 1, 2, 3 . . . n), Aⱼ and Bⱼ are constants, at least one of which is adjustable.

35. The method in accordance with claim 23 wherein the step of amplifying the signal with a gain proportional to a sum of a plurality of terms comprises the substeps of:
for each value of j in the set j={0, 1, 2 . . . n}, amplifying the input signal by a separate constant Aⱼ to produce a separate signal Sⱼ, and
processing signals Sⱼ, for all values of the set j={0, 1, 2 . . . n} to produce the output signal (Vₒᵤₜ) proportional to
B₀S₀+B_{0.5}S_{0.5}+B₁S₁+B₂S₂+ . . . BₙSₙ
wherein coefficients B₀, B_{0.5}, B₁, B₂ . . . Bₙ are independently adjustable constants.

36. The method in accordance with claim 35 wherein each constant Aⱼ is independently adjustable.

37. The method in accordance with claim 35 wherein the step of processing signals Sⱼ, for all values of the set j={0, 1, 2 . . . n} to produce the output signal (Vₒᵤₜ) comprises the substeps of:
for each value of j of the set j={0, 1, 2 . . . n}, producing a differential current Iⱼ that is proportional to BⱼSⱼ, and
producing a signal Vₚ of amplitude proportional to a sum of differential currents Iⱼ for each value of j of the set j={0, 1, 2 . . . n}.

38. The method in accordance with claim 37 wherein the step of processing signals Sⱼ, for all values of the set j={0, 1, 2 . . . n} to produce the output signal (Vₒᵤₜ) further comprises the substep of:
amplifying the cascode stage output signal (Vₚ) to produce the output signal (Vₒᵤₜ).

39. The method in accordance with claim 37 wherein signal Vₚ is a differential signal having a common mode voltage, and wherein the step of processing signals Sⱼ, for all values of the set j={0, 1, 2 . . . n} to produce the output signal (Vₒᵤₜ) further comprises the substeps of:
for each value of the set j={0, 1, 2 . . . n} producing a differential compensating current I_{jc} that is proportional to BⱼSⱼ, and
controlling the common mode voltage of the cascode stage output signal in response to the differential compensating currents I_{jc} for each value of the set j={0, 1, 2 . . . n}

40. The method in accordance with claim 35 wherein the step of amplifying the signal with a gain proportional to a sum of a plurality of terms comprises the substeps of:
processing the input signal V_{IN} to produce a signal P₁ wherein
P₁=log(Vᵢₙ).
amplifying signal P₁ with a gain of A₀ to produce a signal Q₀,
summing Qₒ with 0 to produce a signal R₀,
amplifying signal R₀ to produce a signal S₀=antilog(R₀)
amplifying the input signal (V_{IN}) to produce a signal P₂=log(fVᵢₙ),
for each value of j of the set j={1, 2, 3 . . . n),
subtracting signal P₁ from P₂, for amplifying a result with gain j to produce a signal Qⱼ,
summing signal Qⱼ with a signal of magnitude log(Aⱼ) to produce a signal R, and
processing signal Rⱼ to produce a signal Sᵢ=antilog(Rᵢ); and
amplifying each signal Sⱼ with a separate gain Bⱼ and summing resulting signals to produce the output signal Vₒᵤₜ.
wherein, for each value of j of the set j={0, 1, 2, 3 . . . n), Aⱼ and Bⱼ are constants, at least one of which is adjustable.

41. The apparatus in accordance with claim 2 wherein the circuit comprises a finite impulse response (FIR) filter having m+1 taps, where m is an integer greater than 1, and implementing the transfer function
y/x=C_{0.5}z^{-0.5}+C₀z⁻⁰+C₁z⁻¹+C₂z⁻²+C₃z⁻³ . . . Cₘz^{-m}
wherein x is a magnitude represented of an input to the FIR filter representing the signal to be compensated for attenuation in said transmission media and y is a magnitude of an output of the FIR filter,
wherein coefficients C_{0.5}, C₀, C₁, C₂, . . . Cₙ are independently adjustable constants that are adjusted to compensate for the attenuation in the transmission media, and
wherein for each value of p for the set p={0.5, 0, 1, 2, . . . m}, z^{-p} represents a delay of p cycles of a clock signal.

42. The apparatus in accordance with claim 41 wherein x and x are digital data sequences and the FIR filter is a digital circuit.

43. The apparatus in accordance with claim 41 wherein x and y are analog signals and the FIR filter is an analog circuit.

44. The apparatus in accordance with claim 1 wherein the FIR filter comprises
a plurality of stages, each corresponding to a different value of the set p={0.5, 0, 1, 2, . . . m},
wherein the stage corresponding to p=0.5 produces an output by processing input x with a transfer function C_{0.5}z^{-0.5}, and
wherein the stage corresponding to p=0 produces its output by processing input x with a transfer function C₀z⁰, and
wherein each stage corresponding a value of p of the set p={1, 2, . . . m produces its output signal by processing the output of the stage corresponding to p−1 with a transfer function Cₚz^{-p}, and
a circuit for summing the outputs of the plurality of stages to produce FIR filter output y.
